(19) United States
(12) Patent Application Publication
(10) Pub. No.: US 2024/0302536 A1
(43) Pub. Date: Sep. 12, 2024

(54) Method and Device for Acquiring and Sending GNSS Correction Data

(71) Applicant: Robert Bosch GmbH, Stuttgart (DE)

(72) Inventors: Baohong Cheng, Suzhou (CN); Youxin Huang, Suzhou (CN); Guotao Chen, Suzhou (CN)

(21) Appl. No.: 18/547,650

(22) PCT Filed: Feb. 17, 2022
(86) PCT No.: PCT/EP2022/053932

§ 371 Date: Aug. 23, 2023

(30) Foreign Application Priority Data
Mar. 4, 2021 (CN) 202110242452.0

(51) Int. Cl. G01S 19/07

(52) U.S. Cl. CPC G01S 19/073

(57) ABSTRACT

A method for acquiring GNSS correction data comprises: receiving cell allocation information from a server, wherein the cell allocation information includes information about the coverage of the cells for allocating GNSS correction data, determining target cells corresponding to an electronic terminal according to the received cell allocation information, sending a data acquisition request for acquiring GNSS correction data corresponding to the target cells to the server, and receiving GNSS correction data sent by the server in response to the data acquisition request and corresponding to the target cells from the server. The method and device for acquiring and sending GNSS correction data according to the present disclosure can enable an electronic terminal to acquire only GNSS correction da-ta corresponding to the electronic terminal, thus improving the transmission efficiency of GNSS correction data and saving the electronic terminal's resources for processing GNSS correction data.

### TECHNICAL FIELD

The present invention relates to the field of data processing, in particular to a method and device for an electronic terminal acquiring GNSS correction data and a method and device for a server sending GNSS correction data.

### BACKGROUND ART

As the required positioning/navigation precision increases, it is more and more popular to use a global navigation satellite system (GNSS) for precise positioning/navigation. GNSS correction data is critical during the use of a GNSS for positioning/navigation.

Usually, GNSS correction data is transmitted to an electronic terminal which uses a GNSS for positioning/navigation in the following way: The provider of GNSS correction data, namely, a server, broadcasts all GNSS correction data to all electronic terminals in the coverage and each electronic terminal receives all GNSS correction data. After that, each electronic terminal selects GNSS correction data related to the electronic terminal from all received GNSS correction data for GNSS positioning/navigation.

However, the above-mentioned way of transmitting GNSS correction data makes it necessary to allocate plenty of resources to an electronic terminal which uses a GNSS for positioning/navigation to process GNSS correction data, thus resulting in low efficiency.

### SUMMARY OF THE INVENTION

The object of the present invention is to provide a method and device for an electronic terminal acquiring GNSS correction data and a method and device for a server sending GNSS correction data.

According to one aspect of the present invention, a method for an electronic terminal acquiring GNSS correction data is provided, and the method comprises: receiving cell allocation information from a server, wherein the cell allocation information includes information about the coverage of the cells for allocating GNSS correction data, determining target cells corresponding to the electronic terminal according to the received cell allocation information, sending a data acquisition request for acquiring GNSS correction data corresponding to the target cells to the server, and receiving GNSS correction data sent by the server in response to the data acquisition request and corresponding to the target cells from the server.

According to a further aspect of the present invention, a method for a server sending GNSS correction data is provided and the method comprises: sending cell allocation information to an electronic terminal, wherein the cell allocation information includes information about the coverage of the cells for allocating GNSS correction data, receiving a data acquisition request for acquiring GNSS correction data corresponding to the target cells from the electronic terminal, and sending GNSS correction data corresponding to the target cells to the electronic terminal in response to the data acquisition request.

According to a still further aspect of the present invention, a device for an electronic terminal acquiring GNSS correction data is provided, and the device comprises: an information receiving unit, configured to be able to receive cell allocation information from a server, wherein the cell allocation information in-clues information about the coverage of the cells for allocating GNSS correction data, a cell determination unit, configured to be able to determine target cells corresponding to the electronic terminal according to the received cell allocation information, a data request sending unit, configured to be able to send a data acquisition request for acquiring GNSS correction data corresponding to the target cells to the server, and a data acquisition unit, configured to be able to receive GNSS correction data sent by the server in response to the data acquisition request and corresponding to the target cells from the server.

According to a fourth aspect of the present invention, a device for a server sending GNSS correction data is provided and the device comprises: an information sending unit, configured to be able to send cell allo-cation information to an electronic terminal, wherein the cell allocation information includes information about the coverage of the cells for allocating GNSS correction data, a data request receiving unit, configured to be able to receive a data acquisition request for acquiring GNSS correction data corresponding to the target cells from the electronic terminal, and a data sending unit, configured to be able to send GNSS correction data corresponding to the target cells to the electronic terminal in response to the data acquisition request.

According to a fifth aspect of the present invention, a computer program product is provided, wherein the computer program product comprises a computer program, and when the computer program is executed by a processor, the processor executes the method for an electronic terminal acquiring GNSS correction data or the method for a server sending GNSS correction data according to the present invention.

The method and device for an electronic terminal acquiring GNSS correction data and the method and device for a server sending GNSS correction data according to the present invention enable an electronic terminal to acquire only GNSS correction data of the cell corresponding to the electronic terminal, thus improving the transmission efficiency of GNSS correction data, and saving the electronic terminal's resources for processing GNSS correction data.

### BRIEF DESCRIPTION OF THE DRAWINGS

The detailed description below in combination with the drawings will help you to comprehensively understand the above-mentioned aspects and other aspects of the present invention. In the drawings,

FIG. 1 is a flowchart of the method for an electronic terminal acquiring GNSS correction data according to one exemplary embodiment of the present invention,

FIG. 2 is a flowchart of the method for a server sending GNSS correction data according to one exemplary embodiment of the present invention,

FIG. 3 is a flowchart of the transmission of GNSS correction data between an electronic terminal and a server according to one exemplary embodiment of the present invention,

FIG. 4 is a block diagram of the device for an electronic terminal acquiring GNSS correction data according to one exemplary embodiment of the present invention, and

FIG. 5 is a block diagram of the device for a server sending GNSS correction data according to one exemplary embodiment of the present invention.

### DETAILED DESCRIPTION OF THE INVENTION

Some exemplary embodiments of the present invention will be described in more detail by reference to the drawings so that the basic idea and advantages of the present invention can be better understood.

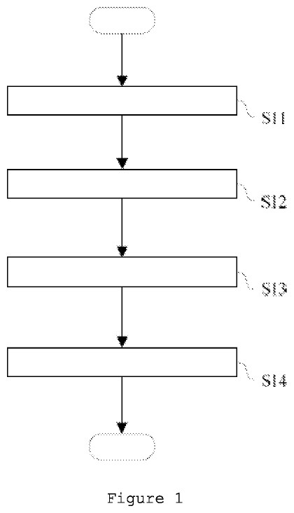

FIG. 1 is a flowchart of the method for an electronic terminal acquiring GNSS correction data accord-in to one exemplary embodiment of the present invention.

The electronic terminal here may be any electronic terminal which uses a GNSS for positioning/navigation, for example, an electronic terminal in a vehicle, or a portable electronic terminal.

See FIG. 1. In step S11, the electronic terminal receives cell allocation information from a server, wherein the cell allocation information includes information about the coverage of the cells for allocating GNSS correction data.

For example, cell allocation information may include the coverage of each cell and the cell ID of the corresponding cell. For example, the coverage of each cell may be represented by the longitudes and latitudes of the borders of the cell.

Here, the electronic terminal may receive cell allocation information in any way in step S11, and for example, the electronic terminal may receive cell allocation information broadcast by the server in L-band. In this case, the server may broadcast cell allocation information to all electronic terminals in the coverage.

Preferably, the electronic terminal may receive cell allocation information sent by the server over a network, for example, a 3G, 4G or 5G network. In this case, as an example, the method for an electronic terminal acquiring GNSS correction data according to the present invention may further comprise the following step: sending an information acquisition request for acquiring cell allocation information to the server. After that, the electronic terminal may receive the cell allocation information sent by the server in re-sponge to the information acquisition request from the server in step S11.

In step S12, the electronic terminal determines target cells corresponding to the electronic terminal according to the received cell allocation information.

For example, the target cells corresponding to the electronic terminal may comprise at least one cell. As an example, the target cells may comprise the cell which the electronic terminal is currently located in, the cell which the electronic terminal will move to and/or at least one cell adjacent to the cell which the electronic terminal is currently located in.

Here, the target cells may be determined by deter-mining the current position of the electronic terminal and the moving tendency of the electronic terminal. As an example, step S12 may comprise determining target cells corresponding to the electronic terminal according to the cell allocation information and the current position of the electronic terminal and/or the position the electronic terminal will move to. Here, the current position of the electronic terminal may be determined in any way, and for example, the current position of the electronic terminal may be determined by a global positioning system (GPS). In addition, the position the electronic terminal will move to may be determined in any way, and for example, the position the electronic terminal will move to may be determined according to the GPS navigation route of the electronic terminal or through a corresponding machine learning model.

For example, in step S12, after the current position of the electronic terminal is determined, the cell covering the current position of the electronic terminal, namely, the cell which the electronic terminal is currently located in, and at least one cell adjacent to the cell which the electronic terminal is currently located in may be determined in combination with cell allocation information, and after the position which the electronic terminal will move to is determined, the cell of the position which the electronic terminal will move to, namely, the cell which the electronic terminal will move to may be determined in combination with cell allocation information.

After that, for example, the cell which the electronic terminal is currently located in, the cell which the electronic terminal will move to and/or at least one cell adjacent to the cell which the electronic terminal is currently located in may be determined to be target cells according to the precision determined for the current position of the electronic terminal and the position which the electronic terminal will move to. For example, when the determined precision is high, only the cell the electronic terminal is currently located in or the cell the electronic terminal is currently located in and the cell which the electronic terminal will move to may be determined to be a target cell(s), and when the determined precision is not high, at least one cell adjacent to the cell which the electronic terminal is currently located in may also be determined to be a target cell. Preferably, at most four cells may be determined to be target cells. However, more, or fewer cells may be determined to be target cells according to the actual requirement.

It should be understood that the above-mentioned way of determining target cells is only an example, and target cells may be determined in different ways according to the actual requirement.

In step S13, the electronic terminal sends a data acquisition request for acquiring GNSS correction data corresponding to the target cells to the server.

Here, after target cells are determined in step S12, GNSS correction data which the electronic terminal needs to use and which will be allocated into a cell or cells may be learned. Therefore, in step S13, the electronic terminal may send a data acquisition request for acquiring GNSS correction data corresponding to the target cells to the server.

In step S14, the electronic terminal receives GNSS correction data sent by the server in response to the data acquisition request and corresponding to the target cells from the server.

Here, by sending a request to the server and receiving only GNSS correction data corresponding to target cells, only GNSS correction data for the electronic terminal, but not all GNSS correction data may be acquired, without disclosing the specific position of the electronic terminal. Thus, with the privacy of the electronic terminal protected, valid GNSS correction data may be acquired efficiently.

The method for an electronic terminal acquiring GNSS correction data according to the present invention enables the electronic terminal to acquire only GNSS correction data of the cell corresponding to the electronic terminal, thus improving the transmission efficiency of GNSS correction data and saving the electronic terminal's resources for processing GNSS correction data.

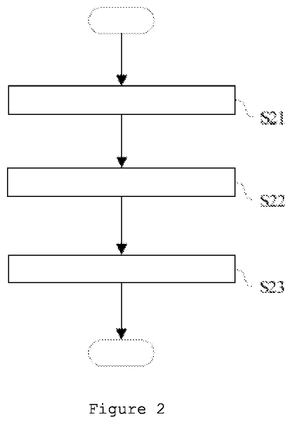

FIG. 2 is a flowchart of the method for a server sending GNSS correction data according to one exemplary embodiment of the present invention.

Here, the server may be the provider of GNSS correction data and the server may have GNSS correction data and information about the coverage of the cells for allocating GNSS correction data.

In step S21, the server sends cell allocation in-formation to the electronic terminal, wherein the cell allocation information includes information about the coverage of the cells for allocating GNSS correction data.

For example, cell allocation information may include the coverage of each cell and the cell ID of the corresponding cell. For example, the coverage of each cell may be represented by the longitudes and latitudes of the borders of the cell.

Here, the server may send cell allocation information to the electronic terminal in any way in step S21, and for example, the server may broadcast cell allocation information in L-band to all electronic terminals in the coverage of the server.

Preferably, the server may send cell allocation information over a network, for example, a 3G, 4G or 5G network. In this case, as an example, the method for a server sending GNSS correction data according to the present invention may further comprise the following step: receiving an information acquisition request for acquiring cell allocation information from the electronic terminal. After that, the server may send cell allocation information to the electronic terminal in response to the information acquisition request in step S21.

In step S22, the server receives a data acquisition request for acquiring GNSS correction data corresponding to the target cells from the electronic terminal.

Here, the target cells may be the cells corresponding to the electronic terminal and determined by the electronic terminal sending a data acquisition request. As an example, the target cells may comprise the cell which the electronic terminal is currently located in, the cell which the electronic terminal will move to and/or at least one cell adjacent to the cell which the electronic terminal is currently located in.

In step S23, the server sends GNSS correction data corresponding to the target cells to the electronic terminal in response to the data acquisition request.

Here, after the data acquisition request is received, GNSS correction data allocated to the target cells may be screened out on the server, and thus GNSS correction data corresponding to the target cells is sent to the corresponding electronic terminal.

The method for a server sending GNSS correction data according to the present invention can enable an electronic terminal to acquire only GNSS correction data corresponding to the electronic terminal, thus improving the transmission efficiency of GNSS correction data and saving the electronic terminal's resources for processing GNSS correction data.

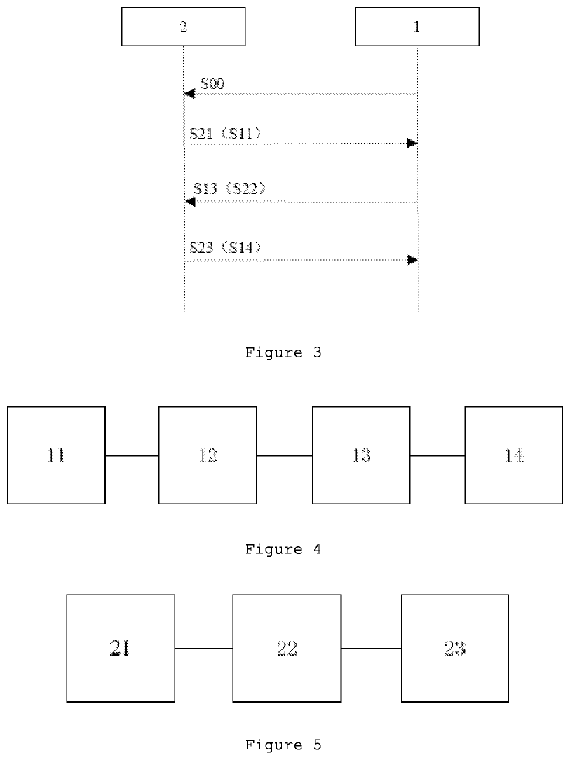

An example of the transmission of GNSS correction data between an electronic terminal and a server by use of the method for an electronic terminal acquiring GNSS correction data and the method for a server sending GNSS correction data according to the present invention is described below by reference to FIG. 3.

FIG. 3 is a flowchart of the transmission of GNSS correction data between an electronic terminal 1 and a server 2 according to one exemplary embodiment of the present invention.

See FIG. 3. When the electronic terminal 1 expects positioning/navigation through a GNSS, the electronic terminal 1 may send an information acquisition request (S00) for acquiring cell allocation information to the server. At this time, the server 2 receives the information acquisition request from the electronic terminal (S00).

After receiving the information acquisition re-quest, the server 2 may send cell allocation information to the electronic terminal 1 in response to the information acquisition request (S21). At this time, the electronic terminal 1 receives cell allocation information from the server 2 (S11).

After that, the electronic terminal 1 may determine the target cells (not shown in FIG. 3) corresponding to the electronic terminal 1 according to the received cell allocation information, and then send a data acquisition request for acquiring GNSS correction data corresponding to the target cells to the server 2 (S13). At this time, the server 2 receives the data acquisition request from the electronic terminal 1 (S22).

After receiving the data acquisition request, the server 2 sends GNSS correction data corresponding to the target cells to the electronic terminal in response to the data acquisition request (S23). At this time, the electronic terminal 1 receives GNSS correction data corresponding to the target cells from the server (S14).

The transmission of GNSS correction data between the electronic terminal and the server in the above-mentioned way reduces the amount of GNSS correction data transmitted between the electronic terminal and the server so that the electronic terminal can acquire targeted GNSS correction data, and thus the transmission and processing efficiencies of GNSS correction data are improved.

FIG. 4 is a block diagram of the device for an electronic terminal acquiring GNSS correction data according to one exemplary embodiment of the present invention.

The device for an electronic terminal acquiring GNSS correction data according to the present invention comprises: an information receiving unit 11, a cell determination unit 12, a data request sending unit 13 and a data acquisition unit 14.

The information receiving unit 11 is configured to be able to receive cell allocation information from a server, wherein the cell allocation information includes information about the coverage of the cells for allocating GNSS correction data.

The cell determination unit 12 is configured to be able to determine the target cells corresponding to the electronic terminal according to the received cell allocation information.

The data request sending unit 13 is configured to be able to send a data acquisition request for acquiring GNSS correction data corresponding to the target cells to the server.

The data acquisition unit 14 is configured to be able to receive GNSS correction data sent by the server in response to the data acquisition request and corresponding to the target cells from the server.

Cell allocation information, the determination of target cells and the transmission of GNSS correction data have been described by reference to FIGS. 1 to 3, and they will not be described here again.

The device for an electronic terminal acquiring GNSS correction data according to the present invention enables the electronic terminal to acquire only GNSS correction data of the cell corresponding to the electronic terminal, thus improving the transmission efficiency of GNSS correction data and saving the electronic terminal's resources for processing GNSS correction data.

FIG. 5 is a block diagram of the device for a server sending GNSS correction data according to one exemplary embodiment of the present invention.

The device for a server sending GNSS correction data according to the present invention comprises: an in-formation sending unit 21, a data request receiving unit 22 and a data sending unit 23.

The information sending unit 21 is configured to be able to send cell allocation information to an electronic terminal, wherein the cell allocation information includes information about the coverage of the cells for allocating GNSS correction data.

The data request receiving unit 22 is configured to be able to receive a data acquisition request for acquiring GNSS correction data corresponding to the target cells from the electronic terminal.

The data sending unit 23 is configured to be able to send GNSS correction data corresponding to the target cells to the electronic terminal in response to the data acquisition request.

Cell allocation information, the determination of target cells and the transmission of GNSS correction data have been described by reference to FIGS. 1 to 3, and they will not be described here again.

The device for a server sending GNSS correction data according to the present invention can enable an electronic terminal to acquire only GNSS correction data corresponding to the electronic terminal, thus improving the transmission efficiency of GNSS correction data and saving the electronic terminal's resources for processing GNSS correction data.

According to an exemplary embodiment of the present invention, a computer program product is provided, wherein the computer program product comprises a computer program, and when the computer program is executed by a processor, the processor executes the method for an electronic terminal acquiring GNSS correction data or the method for a server sending GNSS correction data according to the present invention. The computer program product may comprise computer programs, program codes, instructions or some combinations thereof used for independently or jointly commanding or configuring hardware devices to perform operations as required. Computer programs and/or program codes may comprise programs or computer-readable instructions, software components, software modules, data files and data structures executed by one or more hardware devices. Examples of program codes may include machine codes generated by an encoder and advanced program codes executed by an interpreter.

In addition, the devices according to the exemplary embodiments of the present invention and the units in the devices may be implemented as hardware components or software modules. Furthermore, those skilled in the art can implement the units by use of, for example, a field programmable gate array (FPGA), application specific integrated circuit (ASIC) or processor according to the defined processing performed by the units.

Although the present invention is illustrated and described by reference to specific embodiments, the present invention is not limited to the details given. Modifications may be made to these details within the scope of the present invention.

### DESCRIPTION OF REFERENCE NUMERALS IN THE DRAWINGS

S11. Receive cell allocation information from a server
S12. Determine target cells corresponding to the electronic terminal according to the received cell allocation information
S13. Send a data acquisition request for acquiring GNSS correction data corresponding to the target cells to the server
S14. Receive GNSS correction data sent by the server in response to the data acquisition request and corresponding to the target cells from the server
S21. Send cell allocation information to an electronic terminal
S22. Receive a data acquisition request for acquiring GNSS correction data corresponding to the target cells from the electronic terminal
S23. Send GNSS correction data corresponding to the target cells to the electronic terminal in response to the data acquisition request
S00. Send an information acquisition request for acquiring cell allocation information to the server/receive an information acquisition request for acquiring cell allocation information from the electronic terminal
1. Electronic terminal
2. Server
11. Information receiving unit
12. Cell determination unit
13. Data request sending unit
14. Data acquisition unit
21. Information sending unit
22. Data request receiving unit
23. Data sending unit

1. A method for an electronic terminal acquiring GNSS correction data, the method comprising:
receiving cell allocation information from a server, wherein the cell allocation information includes information about coverage of cells for allocating GNSS correction data;
determining target cells corresponding to the electronic terminal according to the received cell allocation information;
sending a data acquisition request for acquiring GNSS correction data corresponding to the target cells to the server; and
receiving GNSS correction data sent by the server in response to the data acquisition request and corresponding to the target cells from the server.

2. The method according to claim 1, wherein determining target cells corresponding to the electronic terminal according to the received cell allocation information comprises:
determining target cells corresponding to the electronic terminal according to the cell allocation information and the current position of the electronic terminal and/or the position the electronic terminal will move to.

3. The method according to claim 1, further comprising:
sending an information acquisition request for acquiring cell allocation information to the server; and
receiving the cell allocation information sent by the server in response to the information acquisition request from the server.

4. The method according to claim 1, wherein the target cells comprise at least one of a cell in which the electronic terminal is currently located, a cell to which the electronic terminal will move, and at least one cell adjacent to the cell in which the electronic terminal is currently located in.

5. A method for a server sending GNSS correction data, the method comprising:
sending cell allocation information to an electronic terminal, wherein the cell allocation information includes information about coverage of cells for allocating GNSS correction data;
receiving a data acquisition request for acquiring GNSS correction data corresponding to the target cells from the electronic terminal; and
sending GNSS correction data corresponding to target cells to the electronic terminal in response to the data acquisition request.

6. The method according to claim 5, further comprising:
receiving an information acquisition request for acquiring cell allocation information from the electronic terminal; and
sending cell allocation information to the electronic terminal in response to the information acquisition request.

7. The method according to claim 5, wherein the target cells comprise at least one of a cell in which the electronic terminal is currently located, a cell to which the electronic terminal will move, and at least one cell adjacent to the cell in which the electronic terminal is currently located.

8. A device for an electronic terminal acquiring GNSS correction data, the device comprising:
an information receiving unit configured to receive cell allocation information from a server, wherein the cell allocation information includes information about coverage of cells for allocating GNSS correction data;
a cell determination unit configured to determine target cells corresponding to the electronic terminal according to the received cell allocation information;
a data request sending unit configured to send a data acquisition request for acquiring GNSS correction data corresponding to the target cells to the server; and
a data acquisition unit configured to receive GNSS correction data, sent by the server in response to the data acquisition request and corresponding to the target cells, from the server.

9. A device for a server sending GNSS correction data, the device comprising:
an information sending unit configured to send cell allocation information to an electronic terminal, wherein the cell allocation information includes information about coverage of cells for allocating GNSS correction data;
a data request receiving unit configured to receive a data acquisition request for acquiring GNSS correction data corresponding to target cells from the electronic terminal and
a data sending unit configured to send GNSS correction data corresponding to the target cells to the electronic terminal in response to the data acquisition request.

10. A computer program product, comprising:
a computer program which, when executed by a processor, executes the method according to claim 1.

11. A computer product, comprising:
a computer program which, when executed by a processor, executes the method according to claim 5.
